(19) United States
(12) Patent Application Publication
(10) Pub. No.: US 2016/0142009 A1
(43) Pub. Date: May 19, 2016

(54) STATISTICAL DETERMINATION OF SOLAR SYSTEM PERFORMANCE

(71) Applicant: Opower, Inc., Arlington, VA (US)

(72) Inventor: Barry Fischer, San Francisco, CA (US)

(21) Appl. No.: 14/677,654

(22) Filed: Apr. 2, 2015

Related U.S. Application Data
(60) Provisional application No. 62/080,066, filed on Nov. 14, 2014.

(51) Int. Cl. H02S 50/00

(52) U.S. Cl. CPC H02S 50/00

(57) ABSTRACT

Power utilities may not have systematic visibility of the actual performance of customers' solar arrays. One solution to getting data on solar system performance may be through using monitoring hardware and/or software that is connected to a solar system. However, utility companies may not have access to such data since the monitoring hardware/software is commonly owned and operated by utility customers themselves and/or private solar contractors. The subject technology provide methods and systems that can be used to determine a “maximum solar production” baseline, e.g., on a daily basis in view of a set of conditions or factors. In some aspects, the maximum solar production baseline is determined by identifying similar days with “maximum solar potential” but that do not correlate with maximum production. In an example, asymmetry or a delta between maximum potential and maximum production can be used to identify underperformance of power production relative to maximum potential.

### CROSS-REFERENCE TO RELATED APPLICATIONS

The present application claims the benefit of priority to U.S. Provisional Application Ser. No. 62/080,666, filed Nov. 14, 2014, entitled “STATISTICAL DETERMINATION OF SOLAR SYSTEM PERFORMANCE,” which is hereby incorporated by reference in its entirety.

### BACKGROUND

The subject technology relates to systems and methods for determining solar system performance and in particular, for identifying solar system underperformance using electricity consumption data.

### SUMMARY

The subject technology includes computer-implemented method for determining a baseline maximum output for one or more solar arrays, the one or more solar arrays associated with at least one location corresponding to a customer of electricity service; monitoring one or more electricity consumption characteristics of the at least one location associated with the one or more solar arrays to determine if electricity outputs for the one or more solar arrays are below the baseline maximum output, the electricity outputs including a net value of a difference between electricity usage and electricity production by the one or more solar arrays at the at least one location; determining that at least one of the one or more solar arrays is underperforming with respect to electricity production if the electricity outputs for the at least one of the one or more solar arrays is below the baseline maximum output; and providing an alert to the customer, the alert indicating that at least one of the one or more solar arrays is underperforming with respect to electricity production based at least in part on the baseline maximum output.

The subject technology provides a computing device, the computing device comprising: at least one processor; and memory storing instructions that, when executed by the at least one processor, cause the computing device to: determine a baseline maximum output for one or more solar arrays, the one or more solar arrays associated with at least one location corresponding to a customer of electricity service; monitor one or more electricity consumption characteristics of the at least one location associated with the one or more solar arrays to determine if electricity outputs for the one or more solar arrays are below the baseline maximum output, the electricity outputs including a net value of a difference between electricity usage and electricity production by the one or more solar arrays at the at least one location; determine that at least one of the one or more solar arrays is underperforming with respect to electricity production if the electricity outputs for the at least one of the one or more solar arrays is below the baseline maximum output; and provide an alert to the customer, the alert indicating that at least one of the one or more solar arrays is underperforming with respect to electricity production based at least in part on the baseline maximum output.

The subject technology further provides a non-transitory computer readable storage medium storing instructions that causes a computing device to: determine a baseline maximum output for one or more solar arrays, the one or more solar arrays associated with at least one location corresponding to a customer of electricity service; monitor one or more electricity consumption characteristics of the at least one location associated with the one or more solar arrays to determine if electricity outputs for the one or more solar arrays are below the baseline maximum output, the electricity outputs including a net value of a difference between electricity usage and electricity production by the one or more solar arrays at the at least one location; determine that at least one of the one or more solar arrays is underperforming with respect to electricity production if the electricity outputs for the at least one of the one or more solar arrays is below the baseline maximum output; and provide an alert to the customer, the alert indicating that at least one of the one or more solar arrays is underperforming with respect to electricity production based at least in part on the baseline maximum output.

### BRIEF DESCRIPTION OF THE DRAWINGS

In the following description, reference is made to the following figures, and in which are shown by way of illustration specific embodiments in which the subject technology may be practiced. It is to be understood that other embodiments may be utilized and changes may be made without departing from the scope of the subject technology.

FIG. 1 illustrates an example of an electric usage alert system, according to certain aspects of the subject technology.

FIGS. 2 and 3 illustrate examples of different conditions that can impair solar cell functionality or production.

FIG. 4 illustrates an example usage graph for representing electricity usage by a user over a period of time, according to certain aspects of the subject technology.

FIG. 5 illustrates an example usage graph for representing electricity usage by a user over a period of time, according to certain aspects of the subject technology.

FIG. 6 illustrates a flowchart of an example process for the electricity usage alert system described in FIG. 1.

FIG. 7 illustrates an example of an environment for implementing aspects in accordance with various embodiments.

FIG. 8 illustrates an example of a system for electricity usage alerts, according to certain aspects of the subject technology.

FIG. 9 illustrates an example configuration of components of a computing device, according to certain aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

More businesses and homes are installing solar panels. Currently, a new solar power project (e.g., photovoltaic system) including solar panels is installed every 3.2 seconds in the United States. Once installed, the solar panels may be interconnected with a power grid provided by a utility company. To get the full benefit of solar panels, the panels should be operated at full capacity to the extent possible. In an example, if a solar array (e.g., interconnected solar panels) is rated at 6 kilowatts of power production capacity, the solar array should be producing substantially close to 6 kilowatts of power when receiving maximum sun exposure. Although the solar panels may provide electricity to the power grid, the utility company currently may not have a feasible way to measure performance of the interconnected solar panels to identify solar systems that may be underperforming with power production.

Systems for electricity production from solar radiation, or photovoltaic systems, can be based on photovoltaic cells. Photovoltaic cells may be made with semiconductor-based materials (e.g., crystalline silicon, monocrystalline silicon, polycrystalline silicon, ribbon silicon, mono-like-multi silicon, thin film, cadmium telluride, copper indium gallium selenide, silicon thin film, gallium arsenide thin film, etc.) that are able to produce electrical energy from the reception of solar radiation (e.g., sunlight) on the surface of the semiconductor-based material. In an example, each photon from the solar radiation that hits the surface of the semiconductor-based material produces, due to the photoelectric effect (e.g., electrons are excited and dissipate energy as heat or are dislodged and travel through the cell), an electrical current, which can captured. An amount of electricity that is generated by the solar panel therefore may vary according to the amount of sunlight depending on current atmospheric conditions and also the season and the time of the day. A photovoltaic panel (e.g., solar panel), which includes multiple photovoltaic cells that are grouped together, may only absorb a portion of visible part of the electromagnetic spectrum from sunlight. Moreover, the performance of the photovoltaic panel may decrease as temperature increases because a higher temperature increases the conductivity of the semiconductor-based material, inhibiting charge separation, which ultimately lowers the voltage across the cell.

To perform at peak operating capacity, solar panels must be orientated toward the sun, and existing photovoltaic systems, including multiple solar panels, may provide a fixed orientation in which the solar panels are, in most existing cases, directed as southward as possible (e.g., for residences in the northern hemisphere). Solar panels, in some instances, however may not perform at peak operating capacity (output) when some conditions or factors are present. For example, panel output and efficiency can be affected by a variety of factors, including weather conditions, placement of the solar panels, obstructions such as debris, dirt, dust, and/or soot that can fall on the panels. In addition, mechanical problems can impact panel efficiency. In another example, wires and screws can come loose, and panels can get cracked. Additionally, nearby tree branches and leaves can grow and create shaded areas that obstruct sunlight from reaching the panel.

An increasing number of utility companies have strategic reasons to ensure that customers' solar panels are performing well, especially as these utilities look to become comprehensive electricity advisers to customers and look to distributed rooftop solar assets to play a role in reducing grid electricity demand, for example, when grid electricity supply is struggling to satisfy demand, such as on hot summer days, or hours when other intermittent resources like wind turbines are not generating power. Some utilities also have a desire to know how customer's solar panels are performing, for example, so that the utilities can offer accurate and relevant advice for electricity usage, and profitably maximize the capability of distributed solar arrays to reduce peak demand of conventional grid-supplied electricity.

Power utilities generally do not have systematic visibility of the actual performance of customers' solar panel systems. One solution to getting data on photovoltaic system performance may be through using monitoring hardware and/or software that is connected to a solar system. However, utility companies generally do not have access to such data since the monitoring hardware/software is commonly owned and operated by utility customers themselves and/or private solar contractors. Thus, when it comes to information and data about in-field photovoltaic system performance, utilities are generally at a loss.

The subject technology provides methods and systems to address the foregoing problems, for example, by providing algorithms that can be used to determine a “maximum solar production” baseline, e.g., on a daily basis in view of a set of conditions or factors. In some aspects, the maximum solar production baseline is determined by identifying similar days with “maximum solar potential” that may represent a good baseline measurement for electricity output from the photovoltaic system. For example, a day with maximum solar potential for this maximum solar production baseline may be a cloudless dry day characterized by unfettered or unobstructed incident solar radiation onto the solar panels and optimal meteorological conditions (e.g. humidity, wind speed, temperature, etc.) at a given location. The electricity generated by the photovoltaic system on such a day, however, may not necessarily correlate with the “maximum possible electricity production” of the photovoltaic system. In an example, asymmetry or a delta between the maximum solar production baseline (e.g., the maximum solar potential) and the production for the photovoltaic system over a time period (e.g., a day) can be used to identify underperformance of power production relative to maximum potential production. The maximum possible electricity production of the photovoltaic system may correspond to a kilowatt peak value which specifies the output power achieved by each solar panel in the system under full solar radiation (under a given set of test conditions, such as where solar radiation of 1,000 watts per square meter is used to define standard conditions).

As used herein, a photovoltaic array (or solar array) refers to a linked collection of solar panels. Photovoltaic cells may grouped together to be included in a solar module. In an embodiment, when electrically connected and mounted on a supporting structure, solar modules may be grouped together to form a solar panel. A solar array or photovoltaic array includes one or more such solar panels. In some implementations, monitoring and analysis of AMI electric usage data may begin shortly (or immediately) after panel installation/interconnection. Depending on implementation, AMI data can be measured at different intervals (e.g., hourly or sub-hourly) to pinpoint the times of day and/or conditions at which a customer's photovoltaic system appears to be achieving its relative maximum power generation (e.g., generating power at maximum output under such conditions). Such conditions can be satisfied based on variables including: time of day (e.g., solar noon for panels facing south, or later in the afternoon for panels appearing to face west), surface and/or air temperature data, weather data (cloud cover, haze, precipitation, wind speed, humidity, etc.), data-derived knowledge that the customer is not at home or not awake (and thus not consuming non-baseload electricity within the home that would affect net electricity consumption data, and any other evidence indicating the absence of non-baseload electricity consumption occurring in the customer's site. In an example, spiky or non-baseload electricity usage could distort the ability to cleanly evaluate a photovoltaic (PV) array's data signature and determine whether it is achieving ‘maximum power production.’ Spiky electricity usage may indicate, for example, that the customer is at home and using electricity within the residence. As used herein, a baseload electricity consumption in a given customer's residence or site refers to electricity usage, likely when nobody is at home, that may be consumed from running appliances, devices with phantom load/standby power, and other devices that may consume power that are turned on (e.g., automated lights, security system, running computing devices, etc.). Non-baseload electricity consumption refers to the usage of electricity beyond the aforementioned baseload electricity consumption, especially in the situation when somebody is home and using electrical devices, appliances, heating, ventilation, and/or air conditioning that consume electricity.

A particularly effective determination of PV array performance (relative to maximum performance) may be inferred by identifying days or a set of days, where usage readings are consistently and relatively flat before sunrise and after sunset, and where intervening daytime usage readings are characterized by a smooth parabolic sequence of reduced, or in many cases even negative, readings. This data signature or curve would imply that inhabitants are away for an extended period, and thus not using any incremental power through non-baseload consumption behaviors. In such instances, corresponding conditions during such a day(s) could allow, contingent on accompanying ideal environmental conditions such as cloudlessness and temperature, for a transparent determination of maximum power production.

Additionally, wind speed may affect the performance of solar panels. In particular, the wind speed matters because it affects the temperature of the panels, which in turn affects panel performance. In an example, panels perform better at lower temperatures as discussed before, so a breeze/wind-flow that cools off a solar panel can generally make it perform better. The potential electrical power from a PV panel falls as the temperature of the panel rises. The temperature of a panel will depend on several factors: 1) mainly the amount of sun-light, which in bright conditions will heat the panel; and 2) the ambient air temperature and amount of wind which affects the rate heat is conducted away from the panel. In an example, panel temperatures on a bright day may exceed a specific temperature (e.g., 50 C) that is substantially above 25 C many panels are rated at. Consequently, even on a very hot day, when the ambient air temperature is around 35 C, the more air or wind moving over the panels, the greater the heat loss. Effect of such a heat loss may depend on panel orientation and tilt with respect to wind direction and the degree to which the panel is exposed to the wind in the first place. Further, relative humidity of the ambient air may affect the heat transfer rate from solar panels.

Photovoltaic system underperformance that is chronically detected (e.g., over a series of days or weeks), can be used to trigger a notification event. For example, a utility company can be notified that a customer's system(s) are failing or showing issues, or are performing below an acceptable threshold of potential production capacity based on one or more avoidable causes (e.g., hardware failure or damage, dirty panels, shading, mechanical aging, other external force or pattern, etc.).

Methods and systems of the subject technology can also incorporate local “solar neighbor” data, for example, that evaluates system performance of many solar homes in the same neighborhood, or in a similar geographic region, or using other appropriate criteria. By way of example, an electric usage alert system may make determinations on other homes near the customer's location (e.g., in the same neighborhood, within a threshold distance of the customer's location, in the same city as the customer). If the electric usage alert system identifies a number of other nearby homes that appear to have “underperforming” solar systems on a certain day, it is less likely that any specific system is failing, and more likely that another systematic variable (e.g., a local meteorological characteristic, a regional grid problem, astronomical phenomena such as a solar eclipse, and/or some other local factor) is affecting all systems. Such a finding could be used to prevent or postpone the triggering of an underperformance alert for any particular household (e.g., in the affected region or neighborhood) to mitigate false-positive notification(s). For example, if the electric usage alert system identifies that a certain threshold number, proportion, or percentage of nearby homes also appear to be “underperforming” on a particular day, the electric usage alert system may determine that the underperformance of the solar systems are false-positive notifications and not flag the solar systems as underperforming for that day.

Further, seasonal and/or temporal information may be used at least in part to determine whether a given PV array is underperforming. For example, different maximum solar production potential for June versus October (e.g., different seasons) may be considered to determine whether the PV array is currently underperforming based on a current time period of measurement and analysis. Additionally, historical PV production information for a similar time period in the past (e.g., same day a year ago) may also be used and if the current production is substantially dissimilar, the PV array may be underperforming.

If the utility detects that a particular customer's system in chronically underperforming (i.e., relative to its maximum solar production potential, as described above), then an alert can be triggered, for example, providing a customer notification to remind the customer about the importance of cleaning and/or making sure their panels are operating at an acceptably high level of performance.

In some aspects, information regarding a geographic orientation of customers' solar panels can be determined based on net electricity consumption data. For example, in some aspects, knowing the geographic orientation of customers' solar panels can be valuable to utility companies because different orientations produce different outcomes for what time of day a customer's solar electricity production reaches a maximum (e.g., noontime versus 4 pm). Thus, if the geographic orientation of customer solar systems can be determined (i.e., if the “azimuth angle” can be ascertained), the utility can better manage its strategies to manage peak electricity demand, and can uncover key trends in the way in which utility customers are installing solar panels. This ascertainment is supportive of the incorporation of local solar neighbor data as described above, insofar as “solar neighbors” can be sub-categorized depending on system azimuth angle (e.g. homes with west-facing solar arrays should be compared to other homes with west-facing arrays, rather than south-facing arrays).

The “system” described herein may be implemented on a server, and/or on a computing device in communication with a monitoring device, a solar panel installation, or a climate control device. The monitoring device may be a smart meter or, at least in part, include smart meter functionality for measuring electrical, water and/or natural gas consumption in a property associated with a corresponding utility customer. The term “usage” described herein refers to a quantity of use, a cost associated with the use, or a quantified metric representing the use or cost. The term “actual electricity usage” described herein refers to a meter reading or a usage reading. The term “commodity” described herein refers to a utility-based commodity, such as electricity, water, and natural gas, which are consumable finite resources delivered to a dwelling or a commercial structure. The term “component of a property” described herein refers to a component associated with the property that is able to consume a commodity. One example of a component of a property may be a heating, ventilation and air conditioning (HVAC) system that controls the climate within the property using electricity, natural gas, and/or another commodity. The component may relate to one or more of a central heating device, a central air conditioning and heating system, a solar panel array, an appliance, an electronic device, water heating system, a power generating device, a ventilation system, or an air filtration system.

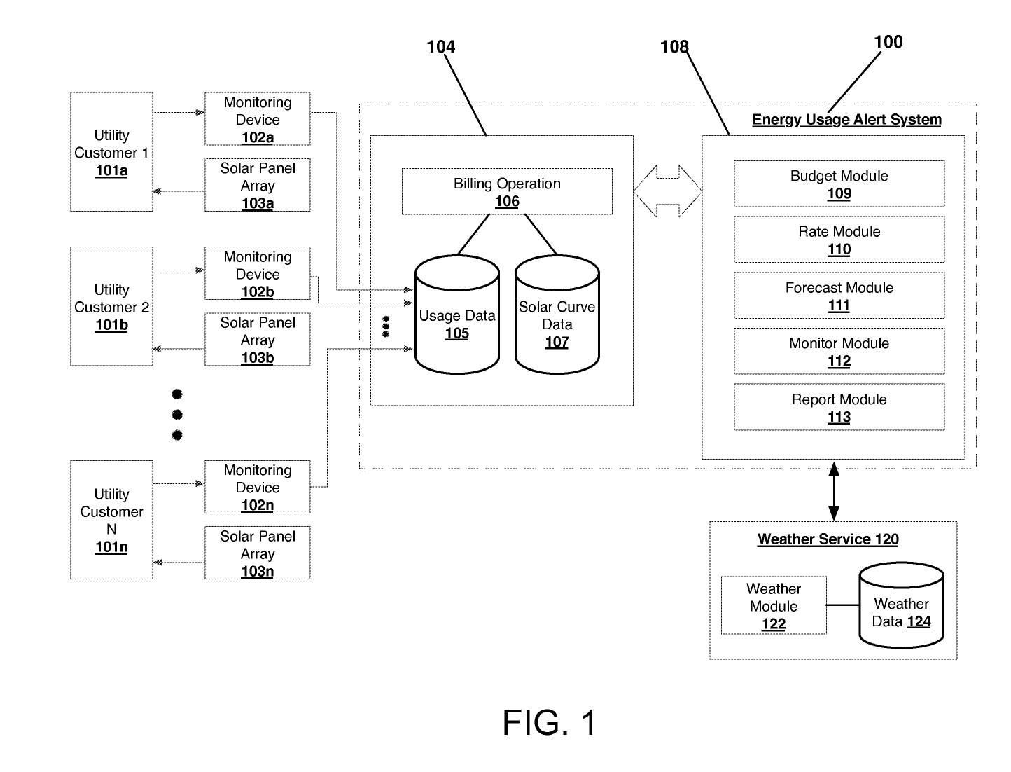

FIG. 1 illustrates an example of an electricity usage alert system 100, according to certain aspects of the subject technology. The electricity usage alert system 100 includes a utility management system 104, which provides AMI data on net electricity consumption as well as basic locational data such as site address and zip code, and a billing management system 108. The utility management system 104 is communicatively coupled to utility customers 101 via monitoring devices, namely a utility-owned advanced or “smart” meter 102, which is installed at the customer site and relays data back to utility. A photovoltaic system is installed at the customer's site. The utility management system 104 includes usage database 105, a billing operation module 106 and solar curve database 107. The utility management system 104 may use data from the smart meter 102, which may be reported as part of utility data provided by the utility to the utility management system 104. The billing management system 108 includes a budget module 109, a rate module 110, a forecast module 111, a monitor module 112, a report module 113 and a recommendation module 114. The billing management system 108 may convey information targeted to one or more of the utility customers 101a-101n over communication channels.

In an example, a customer has a photovoltaic system with solar panels installed at a location or residence that receives electricity from the utility. An advanced or smart meter (hourly or sub-hourly readings) installed by utility will be present at this location. The utility transfers data on location specific AMI electricity usage (e.g., including historical and current usage) to the utility management system 104. As discussed further herein, to use “solar neighbor” data for comparing a given customer's solar curve, usage data for many other customers may be needed.

The utility management system 104 stores usage data in the usage database 105. The usage data is associated with one or more commodities consumed by the utility customers 101. The usage data may include usage information corresponding to usage of at least one of the one or more commodities for multiple utility customers (e.g., utility customers 101a, 101b . . . 101n). The usage-information may include past usage information of the commodity during at least one of completed billing period and a current usage of the at least one of the one or more commodities during a completed portion of a current billing period. The usage data for a utility customer may be obtained from a corresponding monitoring device on a scheduled basis, periodic basis or a non-scheduled basis.

The monitoring devices (e.g., monitoring devices 102a, 102b . . . 102n) may relate to an advanced metering infrastructure (AMI). In this respect, the monitoring devices may be smart meters or, at least in part, include smart meter functionality for measuring electrical, water and/or natural gas consumption in the property associated with the corresponding utility customer. Each of the monitoring devices 102a, 102b, and 102n may have multiple built-in functionalities supporting one or more wired and wireless communications protocols of power line communications and RF technologies, among others. In at least one embodiment, a communication modem or interface (e.g., wired or wireless) may be used to facilitate communications with the utility management system 104. The monitoring devices 102a, 102b, and 102n may further measure and record a household's power consumption (e.g., the aforementioned usage data) for each of the utility customers 101a, 101b to 101n.

Further, the monitoring devices 102a, 102b, and 102n may include automatic meter reading (AMR) meters and/or advanced metering infrastructure (AMI) meters. AMR may include meters where aggregated kWh usage, and demand in some cases, may be retrieved using a drive-by vehicle, a walk-by handheld system, fixed network (e.g., antennas, towers, collectors, repeaters, or other permanently installed infrastructure), or by satellite. In an example, AMR meters can provide the kWh reading and possibly peak kW demand for a given period of time (e.g., month). AMI may include meters that record customer consumption on an hourly basis (or more frequently or less frequently) and provide for daily (or more frequent or less frequent) transmittal of measurements over a communication network to the utility management system 104. AMI meters may provide information, including cumulative kWh usage, daily kWh usage, peak kW demand, last interval demand, load profile, voltage, voltage profile, logs of voltage sag and swell events, voltage event flags, phase information, outage counts, outage logs, tamper notification, power factor, and time-of-use kWh and peak kW readings, among other types of information.

For example, the usage data may consist of usage information corresponding to the property in its entirety such that usage information relating to one or more components in the property is disaggregated by the utility management system 104 and/or the billing management system 108. Additionally or alternatively, the usage data may consist of a multitude of values or readings that represent recorded levels of consumption of a commodity during a number of intervals (e.g., every hour, every 15 minutes, etc.) rather than a total consumption of the commodity in between measuring periods or for a billing period. In another example, the usage data 105 may contain information from non-AMI or non-AMR sources such as an analog meter, which is provided to the utility management system 104 by other means. In an aspect, the utility management system 104 stores and forwards the usage data to the billing management system 108 for usage alert processing. The utility management system 104 may forward the usage data to the billing management system 108 for storage and usage alert processing. The utility management system 104 described herein may refer to a utility company or an offsite third party service provider that is interfaced with the utility company.

In operation, the electricity usage alert system 100 allows for the analysis of usage data 105 associated with a user to determine a solar curve for the user, which may be stored as information in the solar curve database 107. In particular, the utility management system 104 stores solar curve data in the solar curve database 107. The solar curve may represent the user's electricity consumption over a specified time period (e.g., an amount of minutes, an amount of hours, an amount of days, an amount of weeks, an amount of months, etc.). In an example, the solar curve database 107 contains the solar curves for each customer that represent ‘maximum solar production baseline’ curves (as discussed further herein and which may change over time, or seasonally) that subsequent eligible solar curves may be compared with to detect an underperforming photovoltaic system.

The budget module 109 may determine a target budget for the current billing period based on the usage data. In an aspect, the budget module 109 may include a budget advisor, which is an automated system for at least determining one or more candidate budget targets. The rate module 110 may store a local copy of a rate schedule associated with the fees for commodities provided by the utility company. The rate module 110 may be configured to obtain the rate schedule, associated with the current billing period, from the utility company or electric provider. The forecast module 111 may be configured to forecast the projected use of electric by the utility customers 101a-101n based on the corresponding usage data. The forecast module 111 may include an algorithm used to determine the projected use information using rate of use information and billing period information. The monitor module 112 may include an interface to the monitoring devices 102a-102n to obtain the usage data directly and/or include an interface with the utility management system 104 to receive the usage data for further processing by one or more components of the billing management system 108 (e.g., projected use information, rate of use information, target budgets). The report module 113 may be configured to generate a usage alert notification, and cause the usage alert notification to be sent to one or more of the utility customers 101a-101n based on one or more reporting conditions (e.g., projected bill exceeding target budget, current billing period ended, utility customer inquiry, etc.) through the communication channels. The recommendation module 114 may be configured to provide one or more recommendations to one or more of utility customers 101a, 101b to 101n for reducing electricity usage and/or preventing or mitigating bill shock.

The communication channels may carry alert notifications to the utility customers 101a-101n over a wired and/or a wireless communication. Further such notifications may be provided through email, Short Message Service (SMS) or interactive voice response (IVR) channels. Although communication via electronic means is described as example, it is contemplated that the subject technology may use a communication channel that is through printed physical mail. In an embodiment, a message or communication may be sent, through an interface, to a printing and mailing service. The printing and mailing service may then generate physical mail including, for example, alert messages for high electricity usage or abnormal solar electricity production, and then mailing the physical mail to respective addresses of utility customers.

In an aspect, the billing management system 108 sends the alert notifications in a broadcast and/or multicast signal to the utility customers 101a-101n via the climate control devices or other devices (e.g., a smart phone or other mobile device) associated with the utility customers 101a-101n. The billing management system 108 may specifically target one or more of the utility customers 101a-101n, and send a personalized alert notification over a unicast signal. The communication channels may be configured to interface to a smart meter (e.g., the monitoring devices 102a-102n), a thermostat (e.g., a climate control device), a customer's mobile device, a data exchange interface of a cellular network, and other networks.

In some aspects, the electricity usage alert system 100 takes into account of changes in weather data, e.g., from a past period (from which a comparison is made) and a current/near future time, for which the solar curve is made. As illustrated, the electricity usage alert system 100 may receive weather data from a weather service 120. Weather data may be provided by third party data, such as from a vendor of weather data including information regarding wind speed, temperature, humidity, cloud cover, etc. The resolution of such weather data may be as granular as possible (e.g., down to zip code level) and may include more details, such as latitude/longitude. The weather service 120 may include a weather module 122 that stores information for weather as weather data 124. In an embodiment, the weather service 120 may be third party service in which the electricity usage alert system 100 may communicate over a network (not shown) to submit requests for the weather data 124. The weather service 120 may expose an application programming interface (API) to facilitate submission of such requests for the weather data 124. Alternatively, the weather service 120 may be implemented as another set of components included in the electricity usage alert system 100.

As mentioned before, solar panel output and efficiency can be affected by a variety of factors, including obstructions such as debris, dirt, dust, and/or soot that can fall on the panels. In addition, mechanical problems can impact panel efficiency. For example, wires and screws can come loose, and panels can get cracked. In some instances, nearby tree branches and leaves can grow and create shaded areas that obstruct sunlight from reaching the panels.

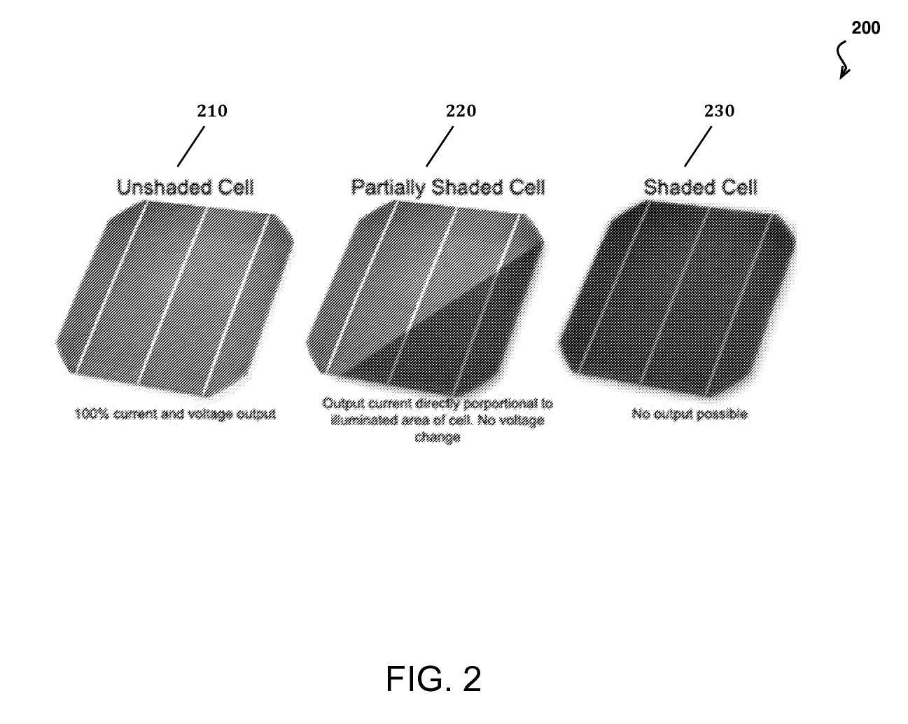

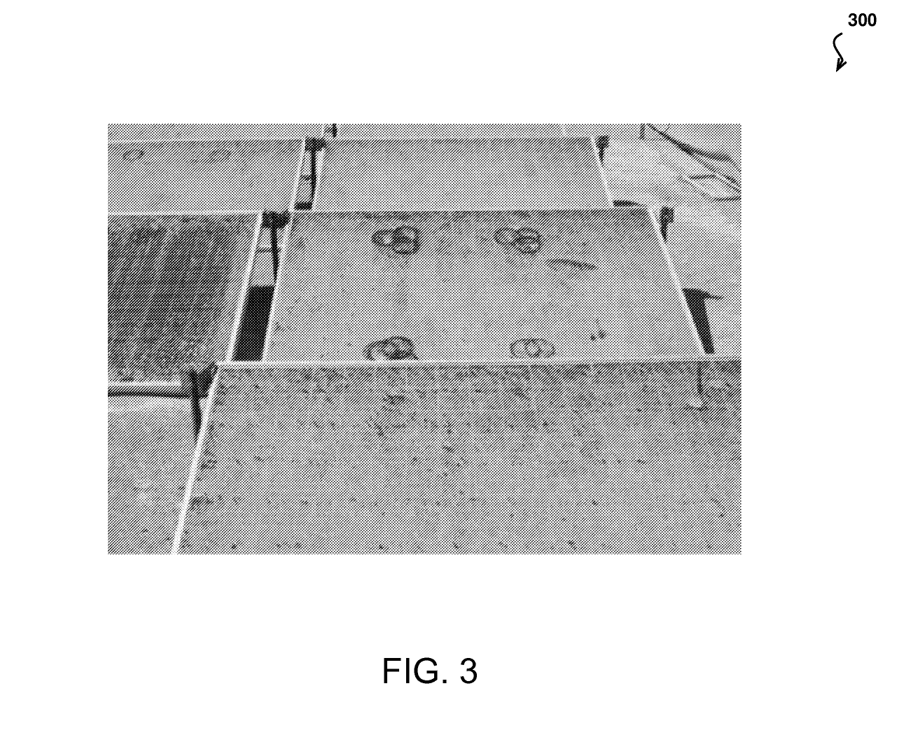

FIGS. 2 and 3 illustrate examples of different conditions that can impair solar cell functionality or production. FIG. 2 shows shading of solar panels according to the varying levels of shading 200 that can occur on the panels. An unshaded cell 210 can potentially provide 100% current and voltage output. A partially shaded cell 220 can provide output current directly proportional to an illuminated area of the cell in which there is no voltage change. In contrast, a shaded cell 230 may not provide any electricity output. An example of debris accumulation 300 is illustrated in FIG. 3 which could impact solar panel electricity production. As illustrated in the example of FIG. 3, debris including dirt, garbage, rubble, dust, pollen, bird droppings or other types of types of natural or manmade accumulated matter may obstruct a portion of the solar panel(s). Such debris may negatively impact the production of electricity from the solar panel(s). An example loss may range from a 25% to 30% loss of electricity production from a solar panel due to debris. These examples represent some of the conditions that can be addressed by customer action (as opposed to weather conditions). In some aspects of the subject technology, the system may be configured to determine if one or more of these conditions may be affecting the production of electricity from a customer's solar panel(s), notify the customer of the conditions, and suggest an action (e.g., clean the solar panels, check for cracks or other malfunctions in the solar panels, or remove objects that might be shading the solar panels) to increase the production of the solar panel(s).

To provide a “clean” solar curve that may be used as a baseline for maximum solar potential production (e.g., under ideal conditions), embodiments may identify and use a fully sunny day that also is characterized by no electricity usage beyond a relatively constant baseload electricity consumption (e.g., refrigerator running) at a customer's residence. As mentioned before, the baseload electricity consumption in a given customer's residence refers to electricity usage, likely when nobody is home, that may be consumed from running appliances, devices with phantom load/standby power, and other devices that may consume power (e.g., automated lights, security system, etc.). In an example, a day (or other time period) with full sun and no one home (or a usage pattern as static or predictable as flatline usage) may be a good candidate for a day in which the baseline for maximum solar potential production may occur.

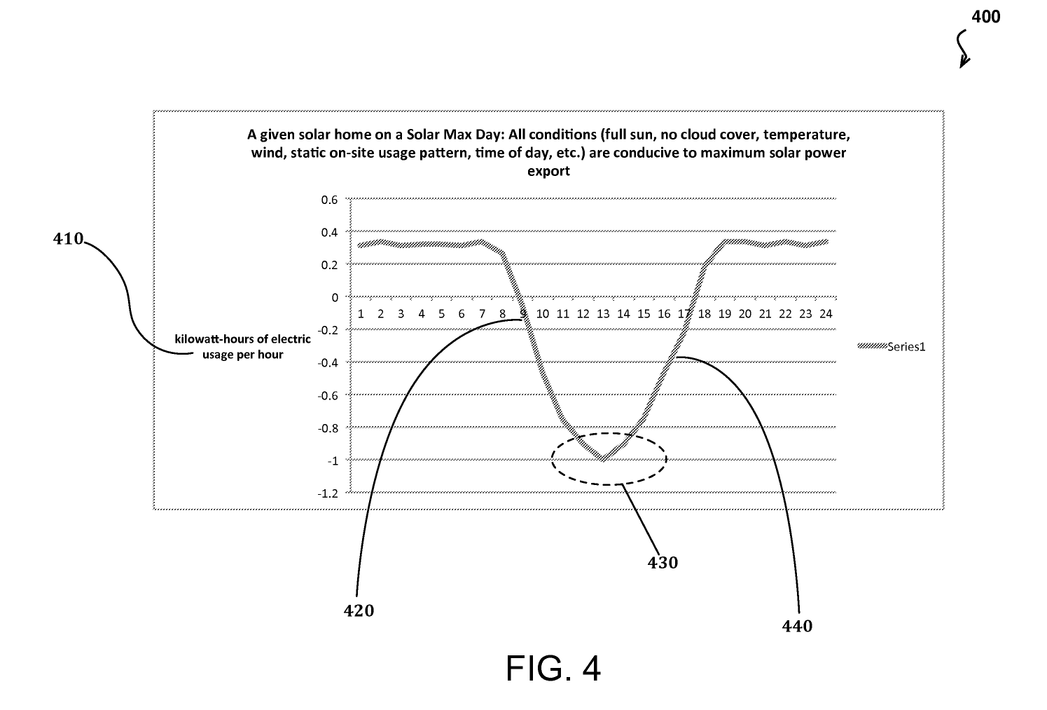

FIG. 4 illustrates an example usage graph 400 for representing net electricity usage by a user over a period of time, according to certain aspects of the subject technology. In an embodiment, the aforementioned system electricity usage alert system 100 may retrieve the net usage data 105 corresponding to the electricity usage of a user to generate a solar curve representing electric consumption over a time period. As illustrated in the example of FIG. 4, the usage graph 400 is graphically represented as an amount of electricity usage (kilowatt hours) on the y-axis over a time period on the x-axis. The time period shown for the usage graph 400 in FIG. 4 is 24 hours of a day along the x-axis.

In the example of FIG. 4, the usage graph 400 represents an example baseline day with a clean solar curve on which the system may base a performance evaluation of a photovoltaic system. The usage graph 400 tracks electricity usage over a time period such as kilowatt-hours of electronic usage per hour 410. As shown, there is little, if any, non-baseload on-site electricity usage, so no distortion of solar export is included in the usage graph 400. With confidence, it may be determined that the solar system is generating approximately 1.3 kWh of electricity at its peak output 430. A downward slope 420 represents less electricity usage over time, while an upward slope 440 represents more electricity usage over time. This may be determined because, in the middle of the day, the otherwise flatline net usage gets pulled down to zero (0.3 kWh) PLUS goes 1 kWh fully negative, e.g., 0.3 kWh+1 kWh=1.3 kWh. Consequently, the usage graph 400 represents a good candidate to serve as a maximum solar production baseline for determining underperformance of the photovoltaic system. The usage graph 400 represents as baseline day that is, equivalently, the electricity output for a maximum solar production baseline. In this example, the day is sunny and on-site electricity usage is not noisy, with smooth transitions indicated by the downward slope 420 and the upward slope 440, such that the usage graph 400 may represent the maximum solar production baseline, which in effect serves as a baseline for future comparison to determine underperformance of the photovoltaic system.

Although the above example discusses generating solar curves, it is appreciated that the subject technology may determine usage patterns (e.g., without a corresponding visual representation) based at least in part on the electricity usage data and then determine if a solar system is underperforming. It is contemplated that the subject technology may utilize either a solar curve or a usage pattern to identifying underperformance of solar panel arrays in accordance with embodiments described herein.

The example above also discusses identifying a baseline output for a solar array based on net usage data one day for simplicity and purposes of illustration. In other embodiments, the system may identify a baseline output for a solar array based on multiple days of usage data. For example, the system may identify a number of days with maximum solar potential based on weather data, retrieve usage data for those days, and determine the maximum solar production baseline for the photovoltaic system based on the retrieved usage data.

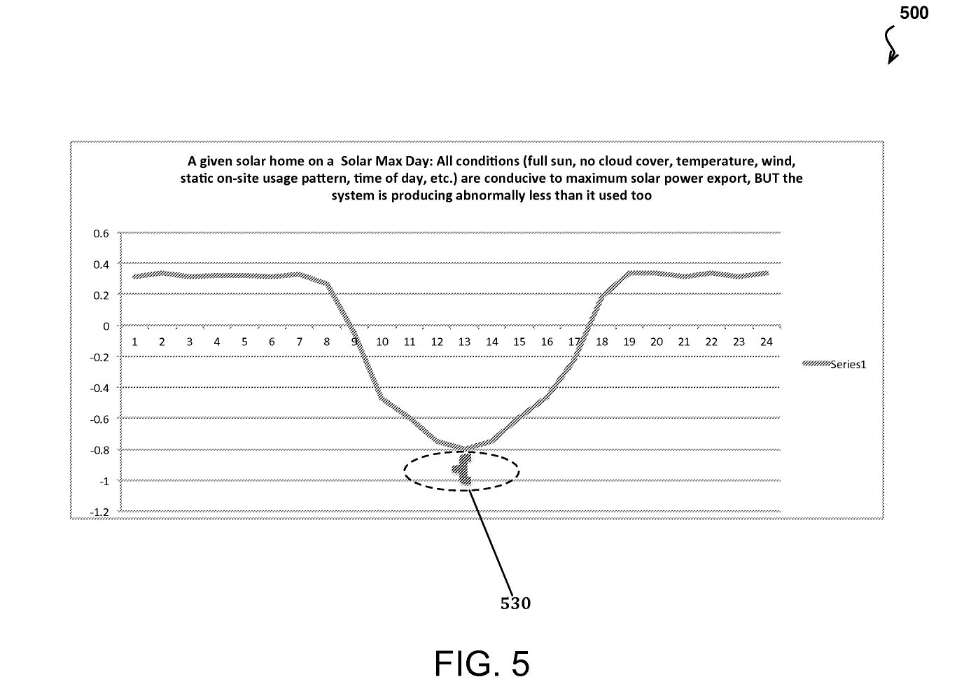

FIG. 5 illustrates an example usage graph 500 for representing electricity usage by a user over a period of time, according to certain aspects of the subject technology. In an embodiment, the aforementioned system electricity usage alert system 100 may retrieve the usage data 105 corresponding to the net electricity usage of a user to generate a solar curve representing net electric consumption over a time period.

Relative to usage graph 400 described above (e.g., with a 1.3 kWh maximum hourly output that may represent the maximum solar production baseline for the photovoltaic system), in the usage graph 500 of FIG. 5 there is a 0.2 kWh shortfall 530 during at around 1 PM (1.1 kWh output for the hour), assuming that weather conditions were the same or similar (e.g., the sun was shining at its maximum brightness and there were no clouds), then it is expected that the photovoltaic system should be producing more strongly under these conditions. Since the photovoltaic system has performed better in the past under similar conditions, it is likely that there is a malfunction or something wrong with the solar panel system. Some degradation of photovoltaic systems over the long term is to be expected, but underperformance may be inferred when persistent statistical drop-offs are observed that can not be explained by standard panel degradation rates.

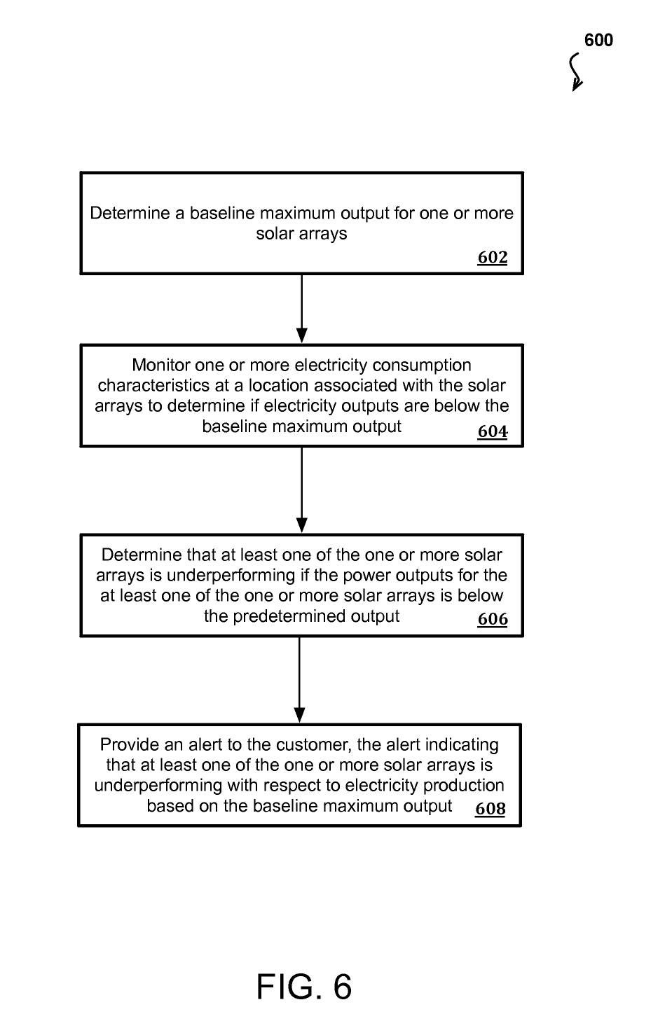

FIG. 6 illustrates a flowchart of an example process 600 for the electricity usage alert system described in FIG. 1. The example process 600 is provided merely as an example and additional or fewer steps may be performed in similar or alternative orders, or in parallel, within the scope of the various embodiments described in this specification. In an embodiment, the example process 600 may be performed to determine whether a given solar panel system is underperforming in comparison with a baseline output for the solar panel system.

At step 602, a baseline maximum output for one or more solar arrays is determined, the one or more solar arrays associated with at least one location corresponding to a customer of electricity service. In an embodiment, one or more days with maximum solar potential for the one or more solar arrays are identified, each of the one or more days not correlating with a maximum production of electricity outputs for the one or more solar arrays. At step 604, electricity consumption characteristics of the at least one location associated with the one or more solar arrays are monitored to determine if electricity outputs for the one or more solar arrays are below the baseline maximum output, the electricity outputs including a net value of a difference between electricity usage and electricity production by the one or more solar arrays at the at least one location. At step 606, it is determined that at least one of the one or more solar arrays is underperforming with respect to electricity production if the electricity outputs for the at least one of the one or more solar arrays is below the baseline maximum output. In some embodiments, the system may determine that at least one of the solar arrays is underperforming if a net difference between the electricity outputs for the solar array and the baseline maximum output exceeds a threshold amount or percentage. At step 608, an alert is provided to the customer, the alert indicating that at least one of the one or more solar arrays is underperforming with respect to electricity production based at least in part on the baseline maximum output.

Although various embodiments of the subject technology relate to detection of underperformance in residential electricity solar panels, other embodiments contemplate the detection of underperformance in commercial solar panels (e.g., solar farms or other commercial solar installations).

Although various embodiments of the subject technology relate to electricity identifying underperformance in electricity solar panels, underperformance in other means of electric production are also contemplated in other embodiments. For example, aspects of the subject technology may relate to identifying a maximum production baseline for a wind turbine or other device configured to translate wind power into electricity based on optimal meteorological conditions (e.g. humidity, wind speed, wind direction, etc.) at a given location, determining that a conditions for a maximum production baseline does not correlate with maximum production. In an example, asymmetry or a delta between maximum potential and maximum production can be used to identify underperformance of power production. If underperformance is detected, the system may generate an alert to appropriate parties.

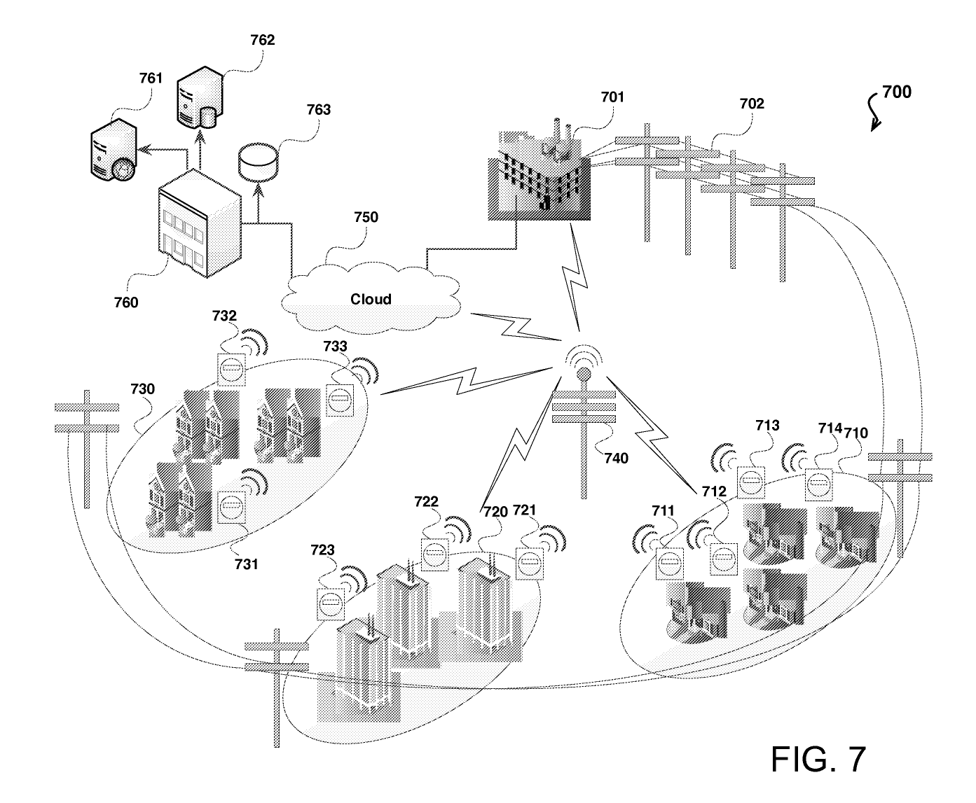

FIG. 7 illustrates an example of an environment 700 for implementing aspects in accordance with various embodiments. The environment 700 includes a utility company 701, power distribution system 702, utility customer regions 710, 720 and 730, electricity usage collector 740, a network 750 and a usage alert system 760. The utility customer region 710 includes residential structures with corresponding smart meters 711-714. The utility customer region 720 includes commercial structures with corresponding smart meters 721-723. The utility customer region 730 includes multi-family structures with corresponding smart meters 731-733. The usage alert system 760 includes a web server 761, an application server 762 and a database 763.

The utility company 701 provides a commodity (e.g., electricity, gas, water) to the utility customer regions 710, 720 and 730. The utility company 701 may track the electricity usage from each region via a monitoring device (e.g., a smart meter) associated with each structure of the corresponding region. The utility company 701 may receive usage data that includes the amount of electric consumption (e.g., kWh) for the corresponding utility account. In an aspect, the utility company 701 receives the usage data from the electricity usage collector 740 via a wireless communication system. In some aspects, the electricity usage collector 740 may obtain the usage data by pulling the usage data from each of the smart meter devices. The smart meter devices may broadcast usage data on a periodic or scheduled basis. The utility company 701 also may receive the usage data from each monitoring device through a wired communication system.

The usage alert system 760 is in communication with the utility company 701 via the network 750. The usage alert system 760 may obtain the usage data from the utility company 701 via the network 750. In an aspect, the usage alert system 760 receives the usage data via the network 750. The usage alert system 760 may receive the usage data directly from the smart meter devices.

Each of the utility customer regions 710, 720 and 730 may correspond to a separate geographical location with a respective rate schedule. In some aspects, an electricity usage alert notification for a corresponding utility customer in one region may be generated using usage data of similar users in the same region to provide the corresponding utility customer with a comparative analysis of its electric consumption (e.g., current electricity usage compared to similar customers in the same zip code or within a certain radius).

The usage alert system 760 also may be in communication with a third party weather service, such as the National Weather Service (not shown). For example, the usage alert system 760 may receive corresponding outdoor temperatures from the third party weather service via the network 750 (e.g., e-mails, downloaded FTP files, and XML feeds). In this respect, the usage alert system 760 may use data from the third party weather service to determine a projected use for a current billing period. For example, forecasted weather conditions (e.g., the temperature, the humidity, the barometric pressure, precipitation, etc.) may indicate that the utility customer's HVAC system is likely to be in greater use. The usage alert system 760 may estimate the projected use for the remaining amount of time of the current billing period, and thereby determine if the utility customer is on pace to exceed the projected bill based on the estimated projected use. In turn, the usage alert system 760 may notify the utility customer through an electricity usage alert notification.

The usage alert system 760 communicates the electricity usage alert notification to utility customers associated with the utility customer regions 710, 720 and 730. In some aspects, the usage alert system 760 communicates the electricity usage alert notification via the network 750. For example, the usage alert system 760 may send the electricity usage alert notification in an e-mail or the utility customer may log into the usage alert system 760 (e.g., the web server 761 and/or application server 762) through an associated website to view the disaggregated usage data included in the electricity usage alert notification. The usage alert system 760 may send the electricity usage information to a printing system so that the electricity usage alert notification can be provided to the utility customer via regular mail (e.g., as part of a utility bill). In other embodiments, the electricity usage information is communicated back to the utility company 701 such that the utility company 701 can provide the electricity usage alert notification to the utility customer.

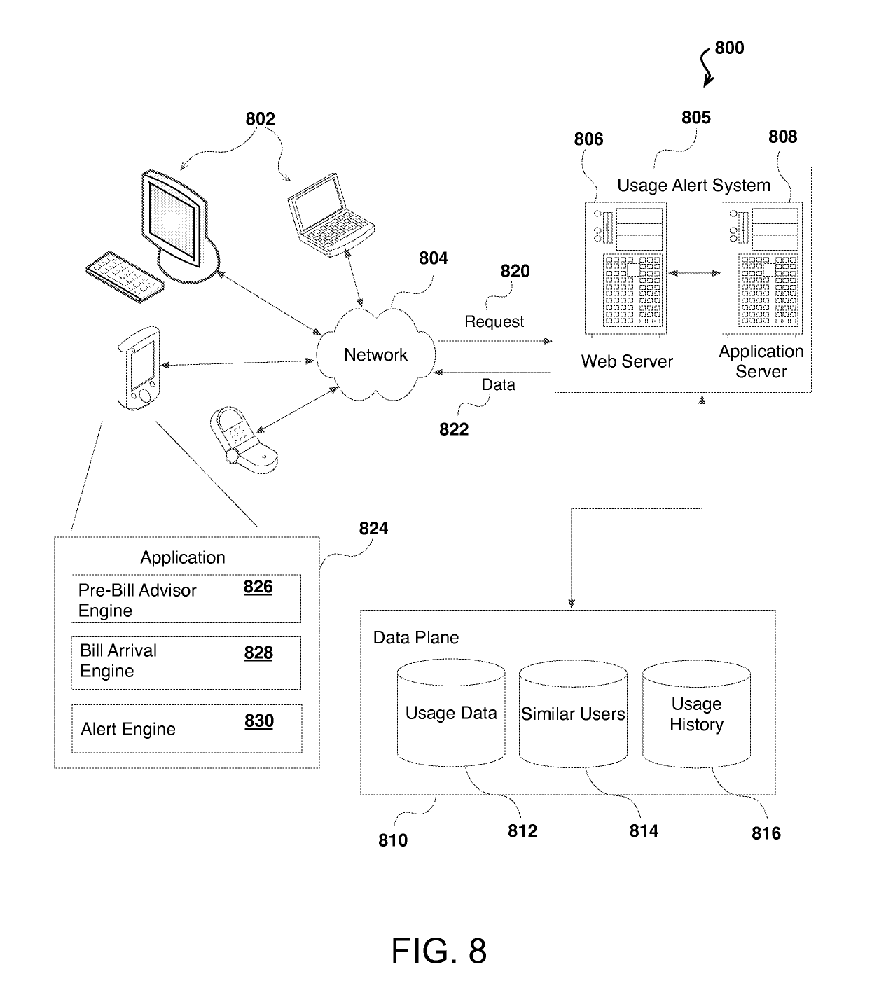

FIG. 8 illustrates an example of a system 800 for electricity usage alerts, according to certain aspects of the subject technology. Although a web-based environment is described for purposes of explanation, different environments may be used, as appropriate, to implement various embodiments.

The example system 800 includes a usage alert system 805 and a data plane 810. The usage alert system 805 includes at least one web server 806 and at least one application server 808, as described below. The usage alert system 805 is an example of an electricity usage notification system implemented as computer programs on one or more computers in one or more locations, in which the systems, components, and techniques described below can be implemented.

A user can interact with the usage alert system 805 through a client device 802. For example, the client device 802 can be a computer coupled to the usage alert system 805 through a data communication network 804, e.g., the Internet. In some instances, the usage alert system 805 can be implemented on the client device 802, for example, through a software application executing on the client device 802. The client device 802 generally includes a memory, e.g., a random access memory (RAM), for storing instructions and data, and a processor for executing stored instructions. The client device 802 can be any appropriate device operable to send and receive requests, messages, or other types of information over the data communication network 804. The client device 802 can also include a display screen though which the user interacting with the client device 802 can view information, e.g., electricity usage alert notification 300 of FIG. 3. Some examples of client devices include personal computers, smart thermostats, cellular phones, handheld messaging devices, laptop computers, set-top boxes, personal data assistants, electronic book readers, tablet devices, smartphones and the like.

The data communication network 804 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The client device 802 can communicate over the data communication network 804 using wired or wireless connections, and combinations thereof.

A user can use the client device 802 to submit a request 820 to log into the usage alert system 805. The request 820 can request a digital copy of an electricity usage alert notification for a corresponding utility account. The electricity usage alert notification may include information relating to how much electric has been consumed to date and/or a projected bill amount for a current billing period. The usage alert notification also can include information relating to one or more recommendations for adjusting settings in the property associated with the corresponding utility account such that the projected bill is kept below a target budget for the current billing period. When the user submits the request 820, the request 820 may be transmitted through the data communication network 804 to the application server 808 within the usage alert system 805. The application server 808 responds to the request 820 by using, for example, usage data 812, to identify data 822 describing an electricity usage alert with personalized information in response to the request 820. The application server 808 sends the data 822 through the data communication network 804 to the client device 802 for presentation to the user.

The data 822 can include data describing a projected bill for a current billing period. The data 822 can be used, for example, by the client device 802, to generate a local electricity usage alert notification with one or more interactive features such as electric consumption adjustments with corresponding utility bill projections and/or instructions for adjusting settings on a climate control device associated with the corresponding utility customer.

After receiving the data 822 from the application server 808, and through the data communication network 804, a software application, e.g., web browser or application 824, running on the client device 802 renders an interactive electricity usage alert notification using the data 822. For example, a pre-bill advisor engine 826 in the application 824 can describe the usage to date including a projected use for the current billing period, for display on a display screen of the client device 802.

In some aspects, the application 824 includes a bill arrival engine 828 that is configured to render an interface to the climate control device, and perform one or more actions related to the instructions for adjusting the settings of the climate control device. In some embodiments, the bill arrival engine 828 is configured to obtain data relating to current settings of the climate control device. The bill arrival engine 828 can obtain real-time statistics and/or sensor readings (e.g., thermometer reading) of current climate conditions in the property. In an aspect, the application 824 includes an alert engine 830 that is configured to render the electricity usage alert notification including allow the user to set (or program) rules and/or conditions for receiving the electricity usage alert notification.

In some embodiments, the web server 806, the application server 808, and similar components, can be considered to be part of the data plane 810. The handling of all requests and responses, as well as the delivery of content between the client device 802 and the application server 808, can be handled by the web server 806. The web server 806 and the application server 808 are merely example components. However, more or fewer components can be used as structured code can be executed on any appropriate device or host machine as discussed elsewhere herein.

The data plane 810 includes one or more resources, servers, hosts, instances, routers, switches, data stores, other similar components, or a combination thereof. The resources of the data plane 810 are not limited to storing and providing access to data. Indeed, there may be several servers, layers, or other elements, processes, or components, which may be chained or otherwise configured, and which can interact to perform tasks including, for example, obtaining data from an appropriate data store. In some embodiments, the term “data store” refers to any device or combination of devices capable of storing, accessing, and retrieving data, which may include any combination and number of data servers, databases, data storage devices, and data storage media, in any standard, distributed, or clustered environment.

The data stores of the data plane 810 can include several separate data tables, databases, or other data storage mechanisms and media for storing data relating to a particular aspect. For example, the data plane 810 illustrated includes mechanisms for storing usage data 812 and user information 816, which can be used to generate the electricity usage alert notification. The data plane 810 is also shown to include a mechanism for storing similar user data 814, which can be used for purposes such as reporting a comparative analysis of the usage data for the corresponding utility customer. The data plane 810 is operable, through logic associated therewith, to receive instructions from the application server 808 and to obtain, update, or otherwise process data, instructions, or other such information in response thereto, as described above.

Each server typically includes an operating system that provides executable program instructions for the general administration and operation of that server, and typically will include a computer-readable medium storing instructions that, when executed by a processor of the server, enable the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment including several computer systems and components that are interconnected through one or more communication links, using one or more computer networks or direct connections. However, the system described above can be configured to operate equally well using fewer or a greater number of components than are illustrated in FIG. 8. Thus, the system 800 in FIG. 8 is provided merely as one example, and does not limit the scope of the disclosure.

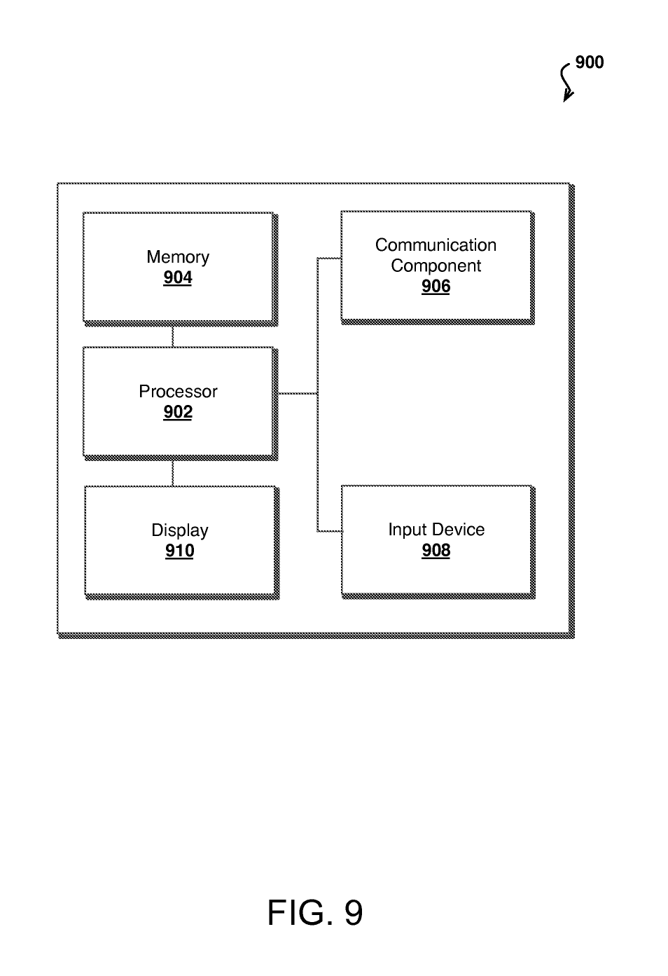

FIG. 9 illustrates an example configuration of components of a computing device 900, e.g., climate control devices, according to certain aspects of the subject technology. In this example, the computing device 900 includes a processor 902 for executing instructions that can be stored in a memory device or element 904. The instructions may cause the computing device 900 to execute a computer-implemented method for processing electricity usage alerts from the electricity usage alert system 90 (FIG. 1) and/or receive instructions to automatically adjust settings (e.g., temperature settings, alarm settings, power settings) of the client computing device 900. As would be apparent to one of ordinary skill in the art, the computing device 900 can include many types of memory, data storage, or non-transitory computer-readable storage media, such as a first data storage for program instructions for execution by the processor 902, a separate storage for usage history or user information, a removable memory for sharing information with other devices, etc. In some embodiments, the computing device 900 can include one or more communication components 906, such as a Wi-Fi, Bluetooth®, radio frequency, near-field communication, wired, or wireless communication system. The computing device 900 in many embodiments can communicate with a network, such as the Internet, and may be able to communicate with other such devices (e.g., the electricity usage alert system 90, other climate control devices). As discussed, the computing device 900 in many embodiments will include at least one input element 908 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. The computing device 900 includes some type of display element 910, such as a touch screen or liquid crystal display (LCD).

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer-implemented method for determining solar cell performance:
determining a baseline maximum output for one or more solar arrays, the one or more solar arrays associated with at least one location corresponding to a customer of electricity service;
monitoring one or more electricity consumption characteristics of the at least one location associated with the one or more solar arrays to determine if electricity outputs for the one or more solar arrays are below the baseline maximum output, the electricity outputs including a net value of a difference between electricity usage and electricity production by the one or more solar arrays at the at least one location;
determining that at least one of the one or more solar arrays is underperforming with respect to electricity production if the electricity outputs for the at least one of the one or more solar arrays is below the baseline maximum output; and
providing an alert to the customer, the alert indicating that at least one of the one or more solar arrays is underperforming with respect to electricity production based at least in part on the baseline maximum output.

2. The computer-implemented method of claim 1, further comprising:
determining one or more values measuring electricity usage at specified intervals over a time period;
determining one or more values measuring electricity output generated by at least one solar array at the specified intervals over the time period; and
for each value measured at each specified interval over the time period, determining a difference value between one value of electricity usage and one value of electricity output; and
determining a peak output value based at least in part on a greatest difference value selected from each of the difference values determined for each value measured at each specified interval over the time period.

3. The computer-implemented method of claim 2, further comprising:
generating a graphical representation of a respective usage curve based at least in part on the difference, for each value measured at each specified interval over the time period, between one value of electricity usage and one value of electricity output.

4. The computer-implemented method of claim 2, wherein the time period is a day and each of the specified intervals are respective hours in the day.

5. The computer-implemented method of claim 1, wherein determining the baseline output further comprises:
identifying one or more days with maximum solar potential for the one or more solar arrays, each of the one or more days not correlating with a maximum production of electricity outputs for the one or more solar arrays.

6. The computer-implemented method of claim 1, wherein monitoring one or more electricity consumption characteristics associated with each of the one or more solar arrays is based on at least one of a time of day, surface or air temperature data, geographic orientation of the one or more solar arrays, or information indicating that the customer is not at home or not awake.

7. The computer-implemented method of claim 1, wherein determining that at least one of the one or more solar arrays is underperforming further comprises:
determining a difference in electricity output between the baseline maximum output and the electricity output of the one or more solar arrays;
determining whether the difference in electricity output exceeds a threshold value, the threshold value based at least in part on a current physical state of the one or more solar arrays; and
indicating that at least one solar array is underperforming responsive to the difference in electricity output exceeding the threshold value.

8. The computer-implemented method of claim 7, further comprising:
providing a notification to the customer that at least one solar array is underperforming.

9. The computer-implemented method of claim 7, wherein the difference in electricity output is caused at least in part by debris covering at least one of the one or more solar arrays.

10. A computing device, the computing device comprising:
at least one processor; and
memory storing instructions that, when executed by the at least one processor, cause the computing device to:
determine a baseline maximum output for one or more solar arrays, the one or more solar arrays associated with at least one location corresponding to a customer of electricity service;
monitor one or more electricity consumption characteristics of the at least one location associated with the one or more solar arrays to determine if electricity outputs for the one or more solar arrays are below the baseline maximum output;
determine that at least one of the one or more solar arrays is underperforming with respect to electricity production if the electricity outputs for the at least one of the one or more solar arrays is below the baseline maximum output; and
provide an alert to the customer, the alert indicating that at least one of the one or more solar arrays is underperforming with respect to electricity production based at least in part on the baseline maximum output.

11. The computing device of claim 10, wherein the instructions further cause the at least one processor to:
determine one or more values measuring electricity usage at specified intervals over a time period;
determine one or more values measuring electricity output generated by at least one solar array at the specified intervals over the time period; and
for each value measured at each specified interval over the time period, determine a difference value between one value of electricity usage and one value of electricity output; and
determine a peak output value based at least in part on a greatest difference value selected from each of the difference values determined for each value measured at each specified interval over the time period.

12. The computing device of claim 11, wherein the instructions further cause the at least one processor to:
generate a graphical representation of a respective usage curve based at least in part on the difference, for each value measured at each specified interval over the time period, between one value of electricity usage and one value of electricity output.

13. The computing device of claim 11, wherein the time period is a day and each of the specified intervals are respective hours in the day and wherein the electricity outputs include a net value of a difference between electricity usage and electricity production by the one or more solar arrays at the at least one location.

14. The computing device of claim 10, wherein the instructions further cause the at least one processor to:
identify one or more days with maximum solar potential for the one or more solar arrays, each of the one or more days not correlating with a maximum production of electricity outputs for the one or more solar arrays.

15. The computing device of claim 10, wherein to monitor one or more electricity consumption characteristics associated with each of the one or more solar arrays is based on at least one of a time of day, surface or air temperature data, geographic orientation of the one or more solar arrays, or information indicating that the customer is not at home or not awake.

16. The computing device of claim 10, wherein the instructions further cause the at least one processor to:
determine a difference in electricity output between the baseline maximum output and the electricity output of the one or more solar arrays;
determine whether the difference in electricity output exceeds a threshold value, the threshold value based at least in part on a current physical state of the one or more solar arrays; and
indicate that at least one solar array is underperforming responsive to the difference in electricity output exceeding the threshold value.

17. The computing device of claim 16, wherein the instructions further cause the at least one processor to:
provide a notification to the customer that at least one solar array is underperforming.

18. The computing device of claim 16, wherein the difference in electricity output is caused at least in part by debris covering at least one of the one or more solar arrays.

19. A non-transitory computer readable storage medium storing instructions on a computing device, the instructions when executed by a processor causing the processor to:
determine a baseline maximum output for one or more solar arrays, the one or more solar arrays associated with at least one location corresponding to a customer of electricity service;
monitor one or more electricity consumption characteristics of the at least one location associated with the one or more solar arrays to determine if electricity outputs for the one or more solar arrays are below the baseline maximum output;
determine that at least one of the one or more solar arrays is underperforming with respect to electricity production if the electricity outputs for the at least one of the one or more solar arrays is below the baseline maximum output; and
provide an alert to the customer, the alert indicating that at least one of the one or more solar arrays is underperforming with respect to electricity production based at least in part on the baseline maximum output.

20. The non-transitory computer readable storage medium of claim 19, wherein the instructions further cause the processor to:
identify one or more days with maximum solar potential for the one or more solar arrays, each of the one or more days not correlating with a maximum production of electricity outputs for the one or more solar arrays.
